(19) United States
(12) Patent Application Publication
(10) Pub. No.: US 2025/0153148 A1
(43) Pub. Date: May 15, 2025

(54) SYSTEMS AND METHODS FOR HIGH TEMPERATURE SYNTHESIS OF SINGLE ATOM DISPERSIONS AND MULTI-ATOM DISPERSIONS

(71) Applicant: UNIVERSITY OF MARYLAND, COLLEGE PARK, College Park, MD (US)

(72) Inventors: Liangbing HU, Woodbridge, CT (US); Yonggang YAO, College Park, MD (US)

(21) Appl. No.: 19/020,174

(22) Filed: Jan. 14, 2025

Related U.S. Application Data
(63) Continuation of application No. 17/618,959, filed on Dec. 14, 2021, now Pat. No. 12,201,964.
(60) Provisional application No. 62/861,639, filed on Jun. 14, 2019.

(51) Int. Cl. B01J 23/46; B01J 19/00; B01J 19/12; B01J 21/18; B01J 23/42; B01J 27/24; B01J 37/08; B01J 37/34

(52) U.S. Cl. CPC B01J 23/462; B01J 19/0013; B01J 19/121; B01J 19/126; B01J 21/18; B01J 23/42; B01J 27/24; B01J 37/08; B01J 37/346; B01J 37/349; B01J 2219/00132; B01J 2219/00141

(57) ABSTRACT

One or more first precursors can be provided on a substrate. The substrate with the one or more first precursors thereon can be subjected to multiple first heating cycles. Each first heating cycle can include a first temperature pulse applied to the substrate for a first duration and a first cooling period following the first temperature pulse. Each first temperature pulse can apply a temperature between 500 K and 4000 K, inclusive. Each first duration can be between 1 millisecond and 1 minute, inclusive.

### CROSS-REFERENCE TO RELATED APPLICATION

This application claims the benefit of, and priority to, U.S. Provisional Patent Application No. 62/861,639, filed on Jun. 14, 2019, which is hereby incorporated by reference herein in its entirety.

### BACKGROUND

### Technical Field

The present disclosure relates to synthesis of atomic dispersions, and more particularly, to high temperature synthesis of single atom dispersions or multi-atom dispersions.

### Related Art

Single atom catalysts offer optimal atom-use efficiency and unique coordination environments and are of great interest for catalytic performance enhancements for many reactions, such as biomass conversion, oxidation, hydrogenation, and electro-catalysis, among others. However, the stability of single atom catalysts remains a challenge due to thermodynamically driven atom aggregation and corresponding performance degradation.

Various approaches have sought to improve the thermal stability of single atoms by enhancing the metal-substrate absorption, using kinetic or spatial confinement, or forming strong metal-substrate bonds. In general, atomic dispersions can be achieved by the confinement and coordination of metal atoms to the substrate in wet chemical synthesis to prevent atom aggregation. The successful synthesis of single atom catalysts at higher temperatures grants higher thermal stability, but high temperature synthesis is challenging to achieve and is incompatible with many temperature-sensitive methods and materials.

In addition, existing technologies are mostly limited to single element single atom catalysts, which do not realize potential synergistic interaction among different atoms that can outperform single atom catalysts and provide new functionalities derived from multi-elements interactions.

### SUMMARY

The present disclosure relates to high temperature synthesis of single atom dispersions or multi-atom dispersions by heating pulses. Aspects of the present disclosure provide dispersed and stable single atoms and/or multi-atom groupings on substrates which have stable atom-substrate bonding.

In accordance with aspects of the present disclosure, a method of synthesizing atomic dispersions includes: positioning a loaded substrate, where the loaded substrate includes a substrate which is loaded with at least one of: a precursor of an element or a cluster of an element; applying one or more temperature pulses to the loaded substrate, where a pulse of the one or more temperature pulses applies a target temperature for a duration, where the target temperature is between 500 K and 4000 K, inclusive, and the duration is between 1 millisecond and 1 minute, inclusive; after the pulse, maintaining a cooling period; and after the one or more temperature pulses, providing single atoms of the element on the substrate.

In various embodiments of the method, the method includes, during the pulse, causing at least partial single atom dispersion of the element on the substrate and forming atom-substrate bonds to stabilize single atoms of the element on the substrate.

In various embodiments of the method, each of the one or more temperature pulses applies the target temperature for the duration, and the method includes, after each of the one or more temperature pulses, maintaining a cooling period.

In various embodiments of the method, the method includes, during each of the at least one temperature pulse, causing at least partial single atom dispersion of the element on the substrate and forming atom-substrate bonds to stabilize single atoms of the element on the substrate.

In various embodiments of the method, the method includes performing at least one iteration of: loading the substrate with at least one of: a precursor of a further element or a cluster of a further element; applying one or more further temperature pulses to the loaded substrate, where each of the one or more further temperature pulses applies the target temperature for the duration; after each of the one or more further temperature pulses, maintaining a cooling period; and after the one or more further temperature pulses, providing multi-atom dispersions of the element and the further element on the substrate.

In various embodiments of the method, the element and the further element are one of: a same element or different elements.

In various embodiments of the method, the element is one of Pt, Ru, or Co.

In various embodiments of the method, the substrate includes one or more of carbon-based materials, metals, ceramics, polymer, composites, or oxides.

In various embodiments of the method, the substrate includes one or more of carbon, C₃N₄, TiO₂, or CO₂-activated carbon nanofiber.

In accordance with aspects of the present disclosure, a system for synthesizing atomic dispersions includes: a loaded substrate including a substrate which is loaded with at least one of: a precursor of an element or a cluster of an element; one or more heating elements; and a controller configured to: control the one or more heating elements to apply one or more temperature pulses to the loaded substrate, where a pulse of the one or more temperature pulse applies a target temperature for a duration, where the target temperature is between 500 K and 4000 K, inclusive, and the duration is between 1 millisecond and 1 minute, inclusive, and after the pulse, maintain a cooling period. After the one or more temperature pulses, single atoms of the element are dispersed on the substrate.

In various embodiments of the system, the pulse causes at least partial single atom dispersion of the element on the substrate and causes formation of atom-substrate bonds to stabilize single atoms of the element on the substrate.

In various embodiments of the system, the one or more heating elements are configured to apply one of: direct Joule heating, conduction heating, radiative heating, microwave heating, laser heating, or plasma heating.

In various embodiments of the system, the controller is configured to: control the one or more heating elements to, for each of the one or more temperature pulses, apply the target temperature for the duration, and after each of the one or more temperature pulses, maintain a cooling period.

In various embodiments of the system, the system includes a conveyor holding the loaded substrate, where the controller is configured to control the conveyor to convey the loaded substrate for heating by the at least one heating element, and where controlling the one or more heating elements to apply the one or more temperature pulses to the loaded substrate includes: controlling the one or more heating elements to maintain the temperature, and controlling a speed of the conveyor to expose portions of the loaded substrate to each of the one or more heating elements for the duration.

In various embodiments of the system, the one or more heating elements include a plurality of heating elements, where the plurality of heating elements are positioned apart such that conveying the portions of the loaded substrate on the conveyor between each of the plurality of heating elements implements the cooling period.

In various embodiments of the system, the loaded substrate is a contiguous strip, and the conveyor continuously conveys the contiguous strip of loaded substrate.

In various embodiments of the system, the loaded substrate is in one of: powder form or droplet form, and the system includes a projection device for projecting the loaded substrate through the one or more heating elements, where controlling the at least one heating element to apply the at least one temperature pulse to the loaded substrate includes: controlling the at least one heating element to maintain the temperature, and controlling a projection speed of the projection device to expose the loaded substrate to each of the at least one heating element for the duration.

In various embodiments of the system, the at least one heating element includes a plurality of heating elements and the plurality of heating elements are positioned apart such that travel of the projected loaded substrate between each of the plurality of heating elements implements the cooling period.

In various embodiments of the system, the element is one of Pt, Ru, or Co.

In various embodiments of the system, the substrate includes at least one of carbon-based materials, metals, ceramics, polymer, composites, or oxides.

In various embodiments of the system, the substrate includes at least one of carbon, C₃N₄, TiO₂, or CO₂-activated carbon nanofiber.

In accordance with aspects of the present disclosure, a structure includes a substrate, dispersed single atoms of an element on the substrate, and bonding between the single atoms and the substrate.

In various embodiments of the structure, the bonding includes one or more of: metallic bonds, covalent bonds, ionic bonds, or Van der Waals forces.

In various embodiments of the structure, the element is one of Pt, Ru, or Co.

In various embodiments of the structure, the substrate includes at least one of carbon-based materials, metals, ceramics, polymer, composites, or oxides.

In various embodiments of the structure, the substrate includes at least one of carbon, C₃N₄, TiO₂, or CO₂-activated carbon nanofiber.

In various embodiments of the structure, the single atoms are catalysts for at least one of: biomass conversion, oxidation, hydrogenation, thermochemical catalysis, electrochemical catalysis, photochemical catalysis, or fundamental study of atomic manipulation.

In accordance with aspects of the present disclosure, a structure includes a substrate, dispersed multi-atom groupings on the substrate, and bonding between the multi-atom groupings and the substrate. Each of the multi-atom groupings include at least two atoms, where the at least two atoms are a same element or at least some of the at least two atoms are different elements. The multi-atom groupings are selected from the group consisting of: bi-atom groupings, tri-atom groupings, groupings of four atoms, or groupings of more than four atoms.

In various embodiments of the structure, the bonding includes one or more of: metallic bonds, covalent bonds, ionic bonds, or Van der Waals forces.

In various embodiments of the structure, the multi-atom groupings include Pt—Ru bi-atoms.

In various embodiments of the structure, the multi-atom groupings include Pt—Co bi-atoms.

In various embodiments of the structure, the substrate includes at least one of carbon nano-fibers, reduced graphene oxide, or C₃N₄.

In various embodiments of the structure, the multi-atom groupings are catalysts for at least one of: biomass conversion, oxidation, hydrogenation, thermochemical catalysis, electrochemical catalysis, photochemical catalysis, or fundamental study of atomic manipulation.

Further details and aspects of exemplary embodiments of the present disclosure are described in more detail below with reference to the appended figures.

### BRIEF DESCRIPTION OF THE DRAWINGS

The above and other aspects and features of the present disclosure will become more apparent in view of the following detailed description when taken in conjunction with the accompanying drawings wherein like reference numerals identify similar or identical elements and:

FIG. 1 is a diagram of exemplary control of high temperature heating pulses, in accordance with aspects of the present disclosure;

FIG. 2 is a diagram of an exemplary individual high temperature heating pulse, in accordance with aspects of the present disclosure;

FIG. 3 is a diagram of exemplary heating configurations for applying high temperature heating pulses, in accordance with aspects of the present disclosure;

FIG. 4 is a diagram of an exemplary process of synthesizing single atom dispersions using high temperature heating pulses, in accordance with aspects of the present disclosure;

FIG. 5 is a diagram of an exemplary process of synthesizing multi-atom groupings using high temperature heating pulses, in accordance with aspects of the present disclosure;

FIG. 6 is a diagram of an exemplary result having 3-atom groupings, in accordance with aspects of the present disclosure;

FIG. 7 is a diagram of an exemplary result having multi-atom groupings, in accordance with aspects of the present disclosure;

FIG. 8 is a diagram of an exemplary heating configuration having multiple heating elements and a conveyor, in accordance with aspects of the present disclosure;

FIG. 9 shows graphs and images relating to applying a high-temperature heating pulse (HTHP) process to synthesize Pt atoms on CO₂-activated carbon nanofiber (CA-CNF) substrates, in accordance with aspects of the present disclosure;

FIG. 10 shows diagrams and graphs relating to single atom bond structure, in accordance with aspects of the present disclosure;

FIG. 11 shows graphs and images relating to applying a HTHP process to various atoms and substrates and for various applications, in accordance with aspects of the present disclosure;

FIG. 12 shows diagrams and images relating to formation of Pt—Ru bi-atom on carbon nanofibers by a HTHP process, in accordance with aspects of the present disclosure;

FIG. 13 is shows high resolution atomic images of formation of bi-atoms on carbon and C₃N₄ substrates by a HTHP process, in accordance with aspects of the present disclosure; and

FIG. 14 is a diagram of an exemplary heating configuration for applying the HTHP process to microsized powder or droplet substrate particles, in accordance with aspects of the present disclosure.

### DETAILED DESCRIPTION

The present disclosure relates to high temperature synthesis of single atom dispersions or multi-atom dispersions by heating pulses. Aspects of the present disclosure provide dispersed and stable single atoms and/or multi-atom groupings on substrates which have stable atom-substrate bonding. Temperatures expressed with the letter “K” will be understood to refer to Kelvins, and temperatures expressed with the letter “C” will be understood to refer to Celsius.

The synthesis process disclosed herein may be referred to as high-temperature heating pulse (“HTHP”). The HTHP process synthesizes and stabilizes single atoms at high temperatures and can be achieved using programmable, periodic on-off heating pulse(s) having a short on-state (e.g., ˜1500 K for ≤55 milliseconds) and a longer off-state (e.g., 10-times longer than on-state, near room temperature). In various embodiments, the on-state provides activation energy for single atom dispersion by forming atom-substrate bonds that can naturally sustain high temperature annealing. The longer off-state achieves overall dispersion stability by preventing extended heating-induced atom aggregation, metal vaporization, and substrate deterioration. The on-off heating pulse(s) lead to atom dispersion while keeping the substrate stable during high temperature exposure.

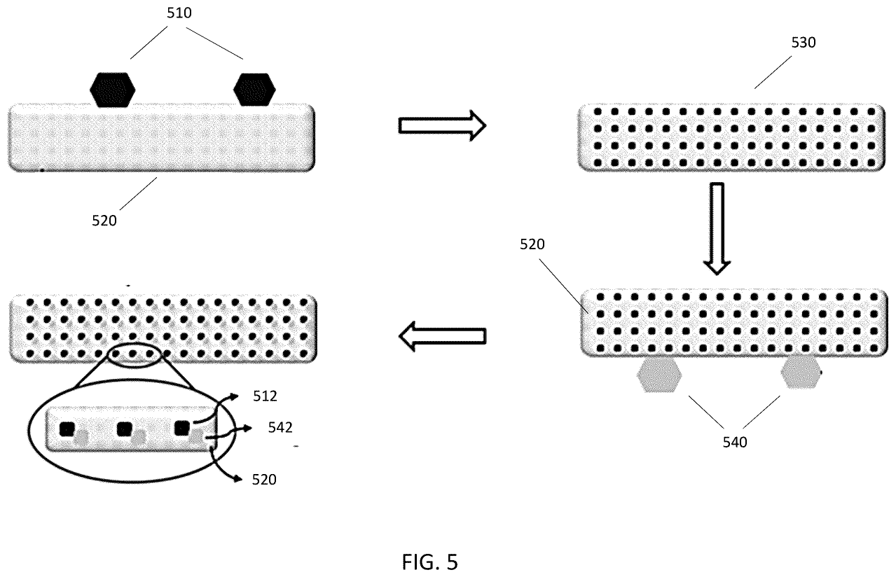

As will be described later herein, the HTHP process can be applied to synthesize multi-atom groupings or atomic alloys, which are composed of the same or different elements where each element is a single atom and is bonded to each other and the substrate. As used herein, the term “multi-atom grouping” refers to and includes groupings of two or more atoms on a substrate resulting from sequential application of the HTHP process, such as groupings of two atoms, of three atoms, of four atoms, or other numbers of atoms. The atoms in a multi-atom grouping may be the same element or may be different elements. For example, all atoms in a multi-atom grouping may be the same element, or all atoms in a multi-atom grouping may be different elements, or some atoms in a multi-atom grouping may be different elements while some atoms in the grouping are the same element. Examples of multi-atom groupings will be described later herein in connection with FIGS. 5-7.

Portions of the present disclosure refer to U.S. Provisional Patent Application No. 62/861,639, filed on Jun. 14, 2019, which has been incorporated by reference in its entirety, and which may be referred to herein as “Supplement.”

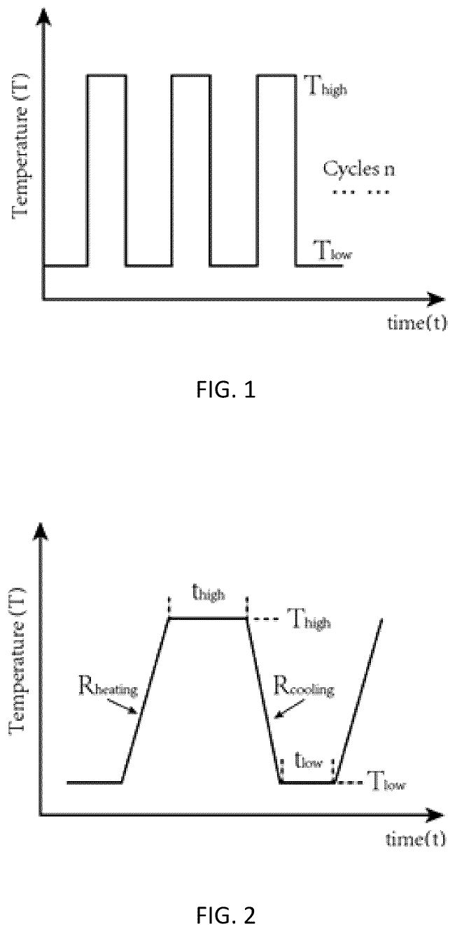

Referring now to FIG. 1, there is shown a diagram of exemplary control of high temperature heating pulses. The illustration of FIG. 1 is not intended to be drawn to scale. The heating pulses can be controlled to achieve a heating on-state target temperature of T_{high}. In various embodiments, the various pulses may not achieve exactly temperature T_{high} and may have temperatures above or below T_{high}, and different pulses may achieve different temperatures. During the heating off-state, the process can be controlled to achieve an off-state target temperature of T_{low}. In various embodiments, the various off-states may not achieve exactly temperature T_{low}, and may have temperatures above or below T_{low}, and different off-state periods may achieve different temperatures. The temperature T_{low} may be, for example, room temperature or ambient temperature.

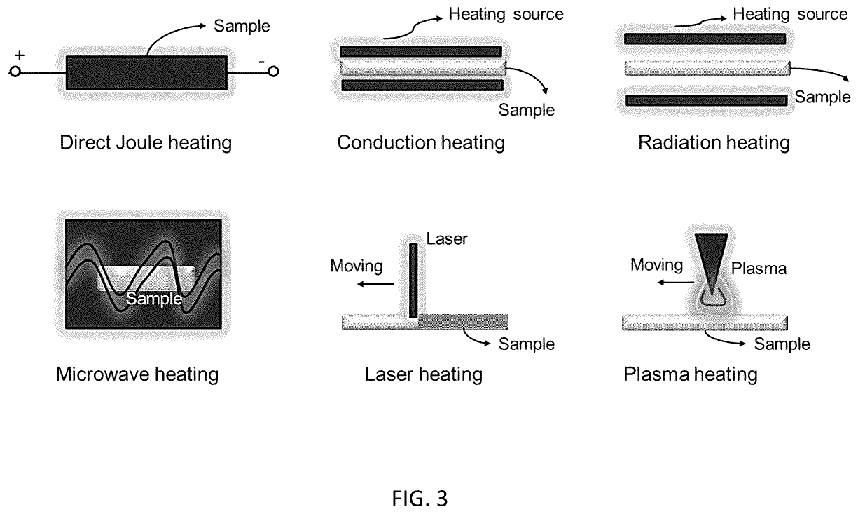

Heating configurations for implementing the temperature pulse control of FIG. 1 are described later in connection with FIG. 3. For now, it is sufficient to note that the temperatures T_{high} and T_{low} may be sensed by one or more temperature sensors, which can sense temperature of a heating element or sense temperature of the environment near a material being heated, among other possibilities. In various embodiments, the temperatures T_{high} and T_{low} may be presumed based on predetermined heating characteristics of a heating element and a heating environment, such as where a temperature sensor is not be used at all or is not used at a desired location.

The control diagram of FIG. 1 is exemplary and variations are contemplated to be within the scope of the present disclosure. For example, although a number of n pulses are illustrated, the HTHP process may implement just a single pulse (n=1) in various scenarios. Additionally, the pulse control is programmable and different control patterns may be implemented. For example, in various embodiments, various pulses can have different target temperatures. Such variations are contemplated to be within the scope of the present disclosure.

FIG. 2 is a diagram of an exemplary individual high temperature heating pulse. The illustration of FIG. 2 is not intended to be drawn to scale. The heating pulse can controlled to ramp up at a heating rate R_{heating}, which may or may not be constant and can be, for example, between 10 K/minute and 10⁷ K/minute, inclusive. When the target temperature T_{high} is achieved, the temperature can be controlled at the target temperature for a duration of t_{high}. In various embodiments, the target temperature T_{high} can be between 500 K and 4000 K, inclusive, and the duration thig for maintaining the target temperature can be between 1 millisecond and 1 minute, inclusive. For example, for a target temperature T_{high} between 1500 K and 2000 K, the duration t_{high} for maintaining the target temperature can be approximately 55 milliseconds. As described above, the actual temperature achieved may not be exactly T_{high} and may be above or below the target temperature.

After the temperature is controlled at the target temperature for the duration t_{high}, the temperature can be controlled to ramp down at a cooling rate R_{cooling}, which may or may not be constant and can be, for example, between −10 K/minute and −10⁷ K/minute, inclusive. When the target temperature T_{low} is achieved, the temperature can be controlled at the target temperature for a duration of t_{low}. In various embodiments, the target temperature T_{low} can be room temperature or ambient temperature, and the duration t_{low} for maintaining the target temperature can be approximately ten times the duration of t_{high}, such as between 10 milliseconds and 10 minutes, inclusive. In various embodiments, the duration t_{low} may not be ten times the duration of t_{high} and can be another time duration. For example, for a t_{high} duration of about 55 milliseconds, the duration of t_{low} can be about 550 milliseconds. As described above, the actual temperature achieved may not be exactly T_{low} and may be above or below the target temperature.

The illustration of FIG. 2 is exemplary and variations are contemplated to be within the scope of the present disclosure. For example, although the heating rate R_{heating} and the cooling rate R_{cooling} are illustrated as constant rates, they may be variable rates that are controlled according to a programmed progression. Additionally, the heating rate R_{heating} and the cooling rate R_{cooling} may be very different from each other, such as when the cooling rate is achieved passively. In various embodiments, the cooling rate can be achieved by active cooling. Such and other variations are contemplated to be within the scope of the present disclosure.

Referring now to FIG. 3, there is shown a diagram of exemplary heating configurations for applying high temperature heating pulses. In accordance with aspects of the present disclosure, any heating configuration can be used if the temperature pulses can be controlled in the manner described in connection with FIGS. 1 and 2. For example, FIG. 3 illustrates six possible configurations, including direct Joule heating, conduction heating, radiative heating, microwave heating, laser heating, and plasma heating. However, other heating configurations not illustrated or described herein can be used. The various configurations can be implemented with a cooling mechanism (not shown), such as, but not limited to, cooling by radiation and conduction, active cooling by conduction and convection, and/or active cooling by physical or chemical transitions that absorb heat, among other possibilities. Depending on which heating configuration is implemented, one or more temperature sensors (not shown) may be deployed at one or more locations, as described above. In various embodiments, the temperatures may be presumed based on predetermined heating characteristics of a heating element and a heating environment, such as where a temperature sensor is not be used at all or is not used at a desired location.

The heating configurations can include a controller (not shown) that is implemented or programmed to control the heating pulses in the manner described in connection with FIGS. 1 and 2. A controller can include, for example, one or more of a central processing unit, a microcontroller, a digital signal processor, a field programmable gate array (FPGA), a programmable logic device (PLD), and/or an application specific integrated circuit (ASIC), among other types of processors and circuits. The heating configurations may also include other components, such as, without limitation, a power source, a fuel source, motors, housings, insulation, and/or other sensors, among other components. Such components are not shown to provide clearer illustrations, but they will be understood and recognized by persons skilled in the art.

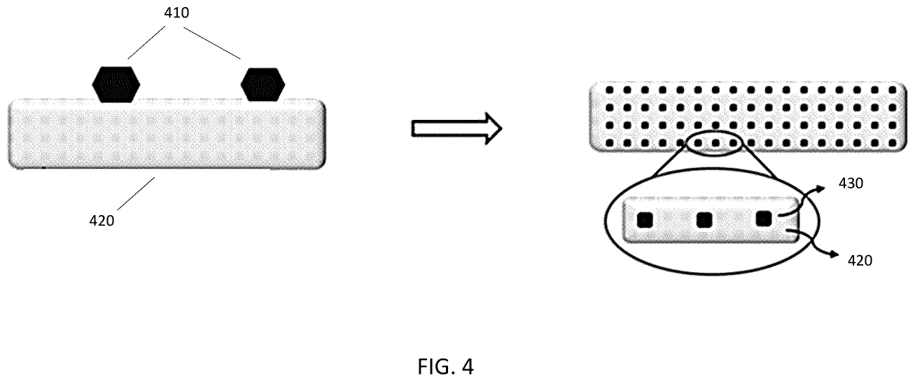

FIG. 4 is a diagram of an exemplary process of synthesizing single atom dispersions using high temperature heating pulses. Precursors or atomic clusters of an element 410 are loaded on a substrate 420, and the HTHP process is applied to the loaded substrate. The loaded substrate 410/420 can be processed in, for example, a heating configuration shown in FIG. 3. The HTHP process converts precursors 410 to the desired atoms 430 and/or disperses atomic clusters 410. The high temperature on-state of the HTHP process promotes single atom 430 dispersion and stabilization by strong atom-substrate bonds, while the off-state achieves overall stability by preventing overheating-induced atom aggregation and substrate deterioration. The on-off heating pulse(s) result in atom dispersion 430 on the substrate 420 while keeping the substrate 420 stable during high temperature exposure. The single atom dispersion effectuated by the HTHP process may not disperse every cluster and some clusters may remain after the HTHP process.

In various embodiments, the single atoms 430 can be any single atom, including, without limitation, Pt, Ru, or Co. In various embodiments, the substrate 420 can be carbon-based materials, metals, ceramics, polymer, composites, oxides, and/or their combinations. For example, the substrate 420 can be carbon, C₃N₄, or TiO₂ substrates, or CO₂-activated carbon nanofiber (CA-CNF) substrates. As used herein, the term “defect” is a feature of a substrate and refers to and includes irregularity in a substrate structure and/or departure/deviation from regular structure of a substrate. As described above, defects in a substrate operate to stabilize single atoms on the substrate. The illustration of FIG. 4 is exemplary and is not intended to be drawn to scale. For example, the single atoms 430 may not be evenly or regularly spaced on the substrate 420. In various embodiments, the single atoms 430 may have uneven or irregular spacing. Additionally, not every atom of the element on the substrate 420 will be a single atom and portions of the substrate 420 may include groupings of multiple atoms of the element.

FIG. 5 is a diagram of an exemplary process of synthesizing multi-atom groupings using high temperature heating pulses. Precursors or clusters of an element A 510 are loaded on a substrate 520, and the HTHP process is applied to the loaded substrate to provide single atom dispersion and stabilization 530. Next, precursors or clusters of an element B 540 are further loaded on the substrate 520, and the HTHP process is applied to the further loaded substrate to provide single atom dispersion and stabilization of atom B 542. By this process, the atoms B 542 can be dispersed and stabilized on the substrate 520 at the same locations as the atoms A 512, thereby forming multi-atom groupings, and/or can be dispersed and stabilized on the substrate 520 at different locations from atoms A 512. In various embodiments, atom A and atom B may be the same element, or atom A and atom B may be different elements.

The illustration of FIG. 5 is exemplary and is not intended to be drawn to scale. For example, the single atoms and multi-atom groupings may not be evenly or regularly spaced on the substrate. In various embodiments, the single atoms or multi-atom groupings may have uneven or irregular spacing. In various embodiments, not every atom A 512 may be grouped with an atom B 542, and not every atom B 542 may be grouped with an atom A 512. Additionally, certain groups on the substrate 520 may include groupings of multiple atoms A 512 or multiple atoms B 542. In other words, the single atom dispersion effectuated by the HTHP process may not disperse every cluster and some clusters may remain after the HTHP process. In various embodiments, the single atoms 512, 542 can be any single atom, including, without limitation, Pt, Ru, and/or Co. In various embodiments, the substrate 520 can be carbon-based materials, metals, ceramics, polymer, composites, oxides, and/or their combinations. For example, the substrate 520 can be carbon, C₃N₄, or TiO₂ substrates, or CO₂-activated carbon nanofiber (CA-CNF) substrates.

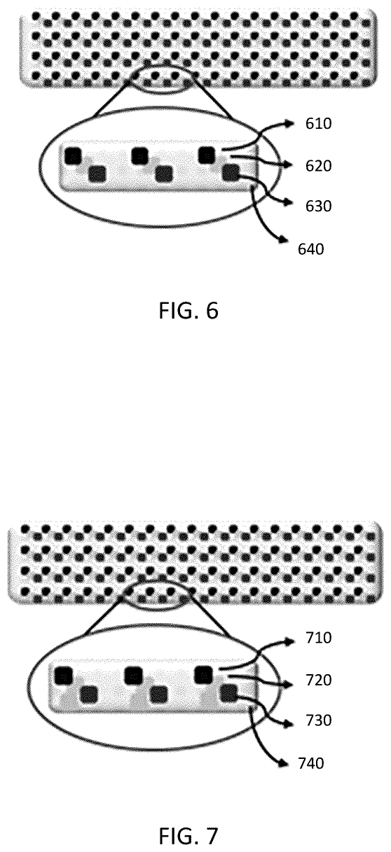

The process of further loading a substrate with another precursor or cluster of an element may be repeated to form larger groupings of multiple atoms. For example, FIG. 6 is a diagram of an exemplary result having 3-atom groupings formed by an atom A 610, an atom B 620, and an atom C 630 on a substrate 640, and FIG. 7 is a diagram of an exemplary result having multi-atom groupings of a number n of atoms formed by an atom A 710, an atom B 720, through an atom n 730 on a substrate 740. The results of FIGS. 6 and 7 can be achieved by sequentially/iteratively loading a substrate and applying the HTHP process to the loaded substrate. The atoms in each grouping can be the same element or can include different elements. In various embodiments, the single atoms can be any single atom, including, without limitation, Pt, Ru, or Co. The substrate can be carbon-based materials, metals, ceramics, polymer, composites, oxides, and/or their combinations. For example, the substrate can be carbon, C₃N₄, or TiO₂ substrates, or CO₂-activated carbon nanofiber (CA-CNF) substrates.

The resulting substrates having single atom dispersions and/or multi-atom dispersions can be used for various applications, such as, without limitation, biomass conversion, oxidation, hydrogenation, thermochemical catalysis, electrochemical catalysis, photochemical catalysis, and/or fundamental study of atomic manipulation, among others.

Accordingly, described above are examples of systems and methods for implementing high temperature heating pulses. The following describes examples of particular systems or examples of particular materials and substrates processed by high temperature heating pulses.

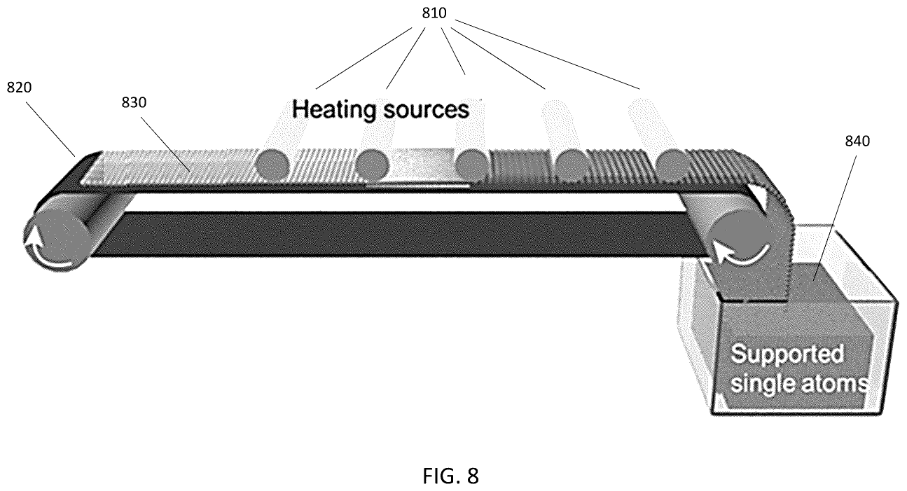

FIG. 8 shows a diagram of an exemplary heating configuration having multiple heating sources/elements 810 and a conveyor 820 that conveys one or more loaded substrates 830 to be heated by the heating elements 810. The heating elements 810 may remain heated and their temperature may not need to be ramped up or down. Rather, the speed of the conveyor 820 can be configured to expose the loaded substrate(s) 830 to an individual heating element 810 for a duration t_{high} corresponding to the on-state of FIG. 2. The positions of the heating elements 810 can be configured such that the travel time of the substrate(s) 830 between heating elements 810 is the duration t_{low} corresponding to the off-state of FIG. 2. When the illustrated configuration is used with a contiguous strip of substrate 830 loaded with precursors or clusters of an element, the HTHP process can be applied continuously to synthesize single atom or multi-atom dispersions 840 at a high synthesis rate.

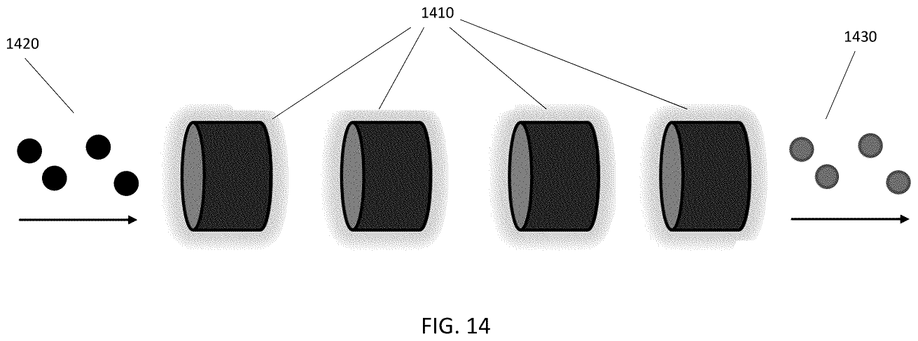

Referring to FIG. 14, there is shown a diagram of an exemplary heating configuration for applying the HTHP process to microsized powder or droplet substrate particles, in accordance with aspects of the present disclosure. The illustrated heating configuration includes multiple heating elements 1410 through which microsized powder or droplet substrate particles 1420 (e.g., aerosolized) may be projected by a projection device (not shown), such as by a sprayer or blower. In various embodiments, the microsized powder or droplet substrate particles 1420 can have substrates having carbon-based materials, metals, ceramics, polymer, composites, oxides, and/or their combinations. The microsized powder or droplet substrate particles 1420 can be loaded with precursors of an element or clusters of an element. The heating elements 1410 may remain heated and their temperature may not need to be ramped up or down. Rather, the speed at which the microsized powder or droplet particles 1420 are projected can be configured to expose the loaded powder or droplet substrate particles 1420 to an individual heating element 1410 for a duration t_{high} corresponding to the on-state of FIG. 2. The positions of the heating elements 1410 can be configured such that the travel time of the substrate(s) 1420 between heating elements 1410 is the duration t_{low} corresponding to the off-state of FIG. 2. When the illustrated configuration is used with a continuous stream of microsized powder or droplet substrate particles loaded with precursors or clusters of an element 1420, the HTHP process can be applied continuously to synthesize single atom or multi-atom dispersions on microsized substrate particles 1430 at a high synthesis rate.

The following will now describe applying the HTHP process to particular atoms and substrates. In the following description, any of the heating configurations can be used, such as any of the heating configurations of FIG. 3, FIG. 8, or FIG. 14.

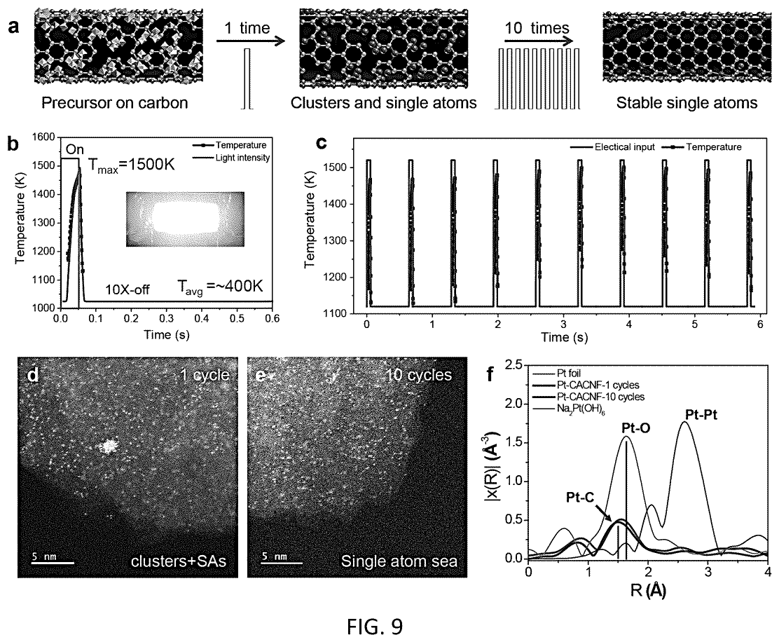

FIG. 9 shows graphs and images relating to applying the HTHP process to synthesize Pt atoms on CO₂-activated carbon nanofiber (CA-CNF) substrates. In FIG. 9, portion (a) is a schematic diagram showing the HTHP synthesis and dispersion process involving carbon atoms, metal precursor, and metallic atoms. Portion (b) shows the temperature evolution during the HTHP synthesis and the detailed heating/cooling pattern. The inset shows the light emitted from the material at high temperature. Portion (c) shows a 10-pulse heating pattern, illustrating the uniform temperature in each cycle with a high temperature on-state and a low temperature off-state. Portions (d) and (e) show high angle annular dark field (HAADF) images of Pt single atoms after 1 and 10 cycles of the HTHP process (0.01 μmol/cm²). Portion (f) shows extended X-ray absorption fine structure (EXAFS) profiles (without phase correction) for Pt single atoms on CA-CNFs after 1 and 10 cycles of the HTHP process.

As schematically shown in FIG. 9, portion (a), ethanol-based salt precursors (H₂PtCl₆) are loaded onto the defective CA-CNFs (e.g., loading 0.01 μmol/cm², normalized to the geometric area) with good wetting. The precursor-loaded CA-CNF film is then subjected to the HTHP process using an electrical Joule heating process that can be programmed in terms of temperature, on-off durations, and repeated cycles (Supplement, Fig. S1). Thermal images captured by a high-speed camera show a uniform spatial temperature distribution during the shock heating process (Supplement, Fig. S2). FIG. 9, portion (b), shows the temperature evolution of a pulse heated to ˜1500 K for 55 milliseconds and then rapidly quenched by directly cutting off the input current for 10 times longer, leading to an average temperature of ˜400 K for the overall process. FIG. 9, portion (c), shows the temperature profile with 10 heating cycles over a 6 second period, demonstrating the relatively stable temperature that can be repeatedly achieved during the heating process. In addition, a temperature up to ˜3000 K can be achieved (Supplement, Fig. S2c), allowing synthesis of thermally stable single atoms at high temperatures.

FIG. 9, portions (d) and (e), show high angle annular dark field (HAADF) images of Pt dispersed on the CA-CNF substrate after 1 and 10 heat pulses at 1500 K. For the single heat pulse, the surface of the CA-CNFs was dispersed with a high-density of single atoms, though Pt clusters are also visible (FIG. 9, portion (d), and Supplement, Fig. S3a). However, after 10 pulses, the substrate displayed a relatively uniform single atom distribution (FIG. 9, portion (d), and Supplement, Fig. S3b), indicating the further disassembly of clusters into single atoms during the continuous HTHP process. The single atom dispersion is confirmed by macroscopic extended X-ray absorption fine structure (EXAFS) (FIG. 9, portion (f)) and X-ray near edge structure (XANES) analysis (Supplement, Fig. S3c). The EXAFS spectrum of the 1-cycle sample shows a weak peak at ˜2.5 Å corresponding to the Pt—Pt bonding, while a dominant peak at ˜1.5 Å indicates the Pt-substrate bonds (Pt—C bond, as discussed later), revealing a structure of Pt nanoclusters mixed with single atoms. After 10 cycles, nearly no Pt—Pt bonds remain, indicating the dominance of single atom dispersion by disassembling the remaining clusters. The CA-CNF substrate has a surface area of ˜56 m²/g and the Pt loading is measured to be ˜0.24 wt %. By varying the metal loading, nanoclusters can form at a higher loading (see Supplement, Fig. S4 for the cases of 0.05 and 0.1 μmol/cm²) due to limited stabilization sites.

To characterize the dispersion mechanism, control samples using different heating strategies (Supplement, Fig. S5a-c) are examined. Low temperature synthesis can lack the activation energy to effectively disperse and bond these atoms to the substrate (i.e., poor dispersion and stability), while high temperature annealing can lead to an unacceptable particle agglomeration due to overheating induced graphitization of the carbon substrate (i.e., losing of defects) and long-range atom diffusion. The HTHP process utilizes high temperature for single atom synthesis but each pulse is short enough to avoid the deterioration to the substrates, thereby maintaining the stability of the single atom dispersion.

As mentioned above, substrate defects help to bind mobile single atoms onto the substrate and improve their structural stability. (See Supplement, Fig. S5d-f). Applying the HTHP process on relatively crystalline CNF (without CO₂ activation) yields nanoclusters mixed with single atoms due to limited defective sites. In contrast, after activation, the improved defect concentration and presence of micro-pores (i.e., carbon vacancies) on CA-CNFs (Supplement, Fig. S6-S7) lead to a high-density single atom dispersion. Accordingly, a more defective substrate can accommodate high density single atoms. Therefore, this illustrates the roles of high temperature heating pulses and defects on the substrate for effective single atom dispersion and stabilization.

Single atoms synthesized by the HTHP process possess structural stability, especially when synthesized at a high temperature of 1500 K, which can be confirmed by in situ scanning transmission electron microscopy (STEM) from room temperature up to 1273 K. A sample can be stabilized for at least 30 minutes before taking images. As shown in Supplement, FIG. 2a, the Pt single atoms display a uniform and high-density single atom dispersion at each temperature up to 1273 K after holding for 60 minutes. In addition, the stability of the Pt single atoms can be confirmed by performing ex situ thermal annealing at 1073 K for 1 hour in a furnace with Ar flow (Supplement, Fig. S8). As the HTHP process can utilizes temperatures through 3000 K (Supplement, Fig. S2c), the HTHP process can enable synthesis of single atoms at an even higher temperatures. As an example, the HTHP process can be applied to synthesize single atoms at 1800 K and 2000 K (using a lesser loading of 0.005 μmol/cm²), and stable single atom dispersion can be seen by both STEM and EXAFS measurement (Supplement, FIG. 2c and Fig. S9).

For comparison, in Supplement, FIG. 2d, reports of single atoms synthesized using various methods are shown. Most wet chemical approaches use a mild temperature and the resulting single atoms are vulnerable under subsequent high temperature annealing, especially when there is no proper bonding or coordination with the substrate. Furnace heating or annealing at 1073-1173 K can substantially increase the thermal stability of single atoms by creating strong and stable metal-substrate bonding through atom trapping and substrate anchoring. However, the much higher temperature of the HTHP process surpasses furnace heating with the ability to synthesize single atoms through 1500-2000 K. In addition, a higher temperature synthesis provides ultrafast kinetics for single atom dispersion with much shorter processing durations (e.g., <10 seconds) and higher efficiency compared to low temperature methods.

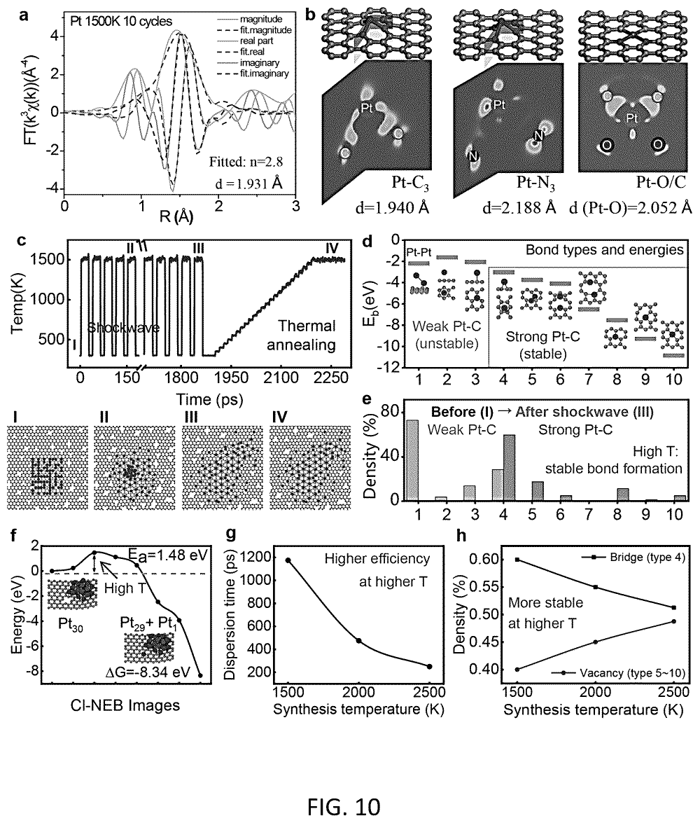

With regard to single atom bond structure, the thermal stability resulting from the HTHP process comes from the ability of the Pt-substrate bond to resist high temperature annealing. FIG. 10 shows diagrams and graphs relating to single atom bond structure. Portion (a) shows first-shell model EXAFS fitting of the Fourier transform at Pt L₃-edge for a Pt-1500K-10 cycle sample, showing a bond distance of 1.931 Å with a coordination number of 2.8. Portion (b) shows density functional theory (DFT) calculated bond distances in the Pt—C₃, Pt—N₃, and Pt—O₂C₂ configurations. Portion (c) shows molecular dynamic (MD) simulation on the single atom dispersion (I-III) and subsequent annealing (IV) at 1500 K. Portion (d) shows identified Pt—Pt (type 1) and Pt—C bonds (type 2-10) in the dispersion system. Portion (e) shows the statistic distribution of bond configurations before (I) and after shockwave synthesis (III): the weak bonds become strong Pt—C bonds. Portion (f) shows energy analysis of a Pt atom deviated from a Pt-30 cluster by forming a thermodynamically stable Pt—C bond (type 10). Portion (g) shows time needed for single atom dispersion, and portion (h) shows associated bond configuration at different synthesis temperatures. The high temperature provides the activation energy for the bond formation, showing a higher dispersion efficiency with more stable Pt—C bonds (type 5-10) at higher synthesis temperatures.

With continuing reference to FIG. 10, the bond structure can be analyzed by extracting the nearest-neighbor coordination numbers and the local structure of the Pt single atoms from fitting the EXAFS profiles with first-shell model (Supplement, Table 1 and Fig. S10). FIG. 10, portion (a), shows an EXAFS fitting of Pt 1500K single atoms, rendering a bond distance of 1.931 Å and a coordination number of 2.8 (indicating a Pt—X₃ bond configuration). The bond length is considerably shorter than the literature reported Pt—O (2.01-2.05 Å) and Pt—N bonds (˜2.3 Å), but is in good agreement with a Pt—C bond having a calculated bond length of 1.93 Å. Moreover, based on this Pt—X₃ bond model, the bond distance of Pt—C in Pt—C₃, Pt—N in Pt—N₃ and Pt—O in Pt—O₂C₂ can be calculated using density functional theory (DFT). The calculated Pt—C bond in Pt—C₃ configuration shows a bond distance of 1.940 Å, which is very close to the fitted result, while Pt—N and Pt—O bonds all have much larger bond distances (FIG. 10, portion (b)), confirming the Pt—C bond structure in the samples.

The DFT result also reveals that the bonding energy of Pt—C bonds is higher than Pt—N bonds under the similar bond configurations (Pt—X₃ and Pt—X₄) (Supplement, Fig. S11a). In addition, the charge density difference diagrams further illustrate the difference between Pt—C and Pt—N bonds: in Pt—C bonds, large amount of charge transfer appears between Pt and C atoms and the charge density is mainly concentrated in the center, indicating strong covalent bond nature; while in Pt—N bonds, the transferred electron is mainly circulated around the Pt and N atoms, which denotes an ionic bond (Supplement, Fig. S11b). Therefore, the Pt—C bonds demonstrate a higher binding energy and a unique covalent nature compared with Pt—N bonds in a similar bond configuration.

To understand the atomistic origin of the high temperature induced dispersion and stabilization, molecular dynamic (MD) simulations using the reactive force field (ReaxFF) potential can be performed. (See Supplement, SI Methods section). The defects on graphene contain randomly etched carbon vacancies to mimic the surface of CA-CNFs. FIG. 10, portion (c), depicts the dispersion of Pt clusters into single atoms with increasing heating cycles at 1500 K (from I to III), as well as the dispersion stability upon thermal annealing at 1500 K (IV). Both the agglomeration and atomization of Pt atoms can be seen, while the atomization can only be stabilized when energy-favorable Pt—C bonds are formed (type 4-10 in FIG. 10, portion (d)). FIG. 10, portion (e), shows the evolution of bond structures before and after the HTHP process at 1500 K, where all the initial weak bonds (Pt—Pt and type 1-3 Pt—C) change into strong Pt—C bonds (type 4-10) with higher binding energies, illustrating the atomic origin of why the single atoms synthesized by the HTHP process are more thermally stable than Pt clusters. The simulation clearly reproduced the synthesis process where the initial Pt clusters are weakly attached with the substrate, but with more HTHP heating, the clusters are disassembled into single atoms by forming strong Pt—C bonds that can sustain high temperature annealing. This also indicates that defects operate to stabilize single atoms and determine the dispersion density.

In the process, high temperature operates to provide sufficient activation energy for atom diffusion and overcome the energy barrier for bond formation. As an example, when a single Pt atom deviated from a Pt-30 cluster to form a Pt—C bond, kinetically there is an energy barrier (e.g., 1.48 eV) hindering the dispersion, which can be overcome at a high temperature (FIG. 10, portion (f), and Supplement, Fig. S12). The HTHP dispersion at other temperatures can also be simulated: 500 K, 1000 K, 2000 K, and 2500 K (Supplement, Fig. S13). Although similar HTHP heating pulse patterns (on/off ratio and cycle numbers) were applied, temperatures 500 K and 1000 K fail to fully disperse the Pt cluster within the given repeated cycles. In contrast, higher HTHP heating pulse temperatures have improved kinetics and achieve single atom dispersion much faster, i.e., a much higher dispersion efficiency (FIG. 10, portion (g)). Moreover, the Pt—C bond distribution in these single atoms shows increasing proportion of more stable type 5-10 bonds at higher synthesis temperatures, indicating improved thermal stability (FIG. 10, portion (h)). Therefore, high temperature synthesis for single atom dispersion and stabilization provides the activation energy, accelerates the dispersion process, and promotes more stable bond formation. For clarity, it is noted that the single atom dispersion effectuated by the HTHP process may not disperse every cluster and some clusters may remain after the HTHP process.

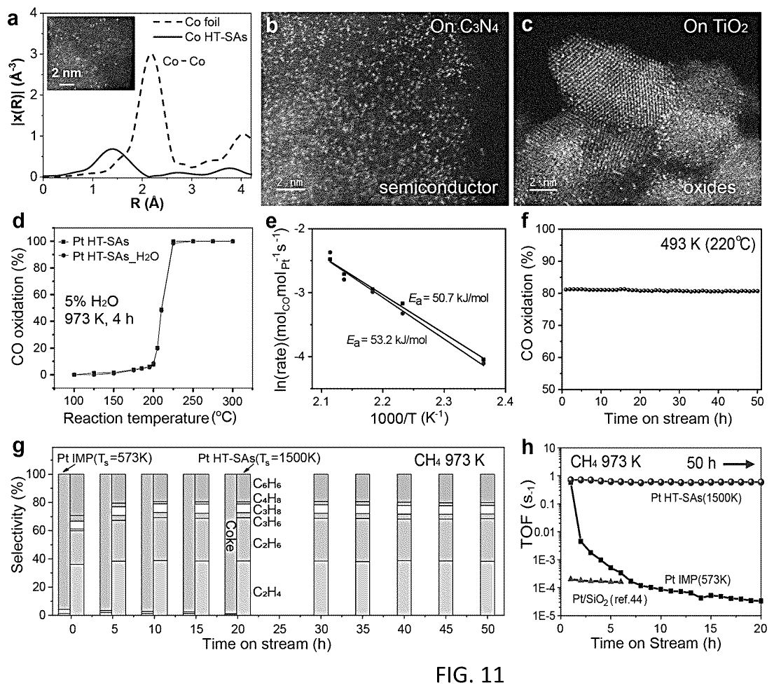

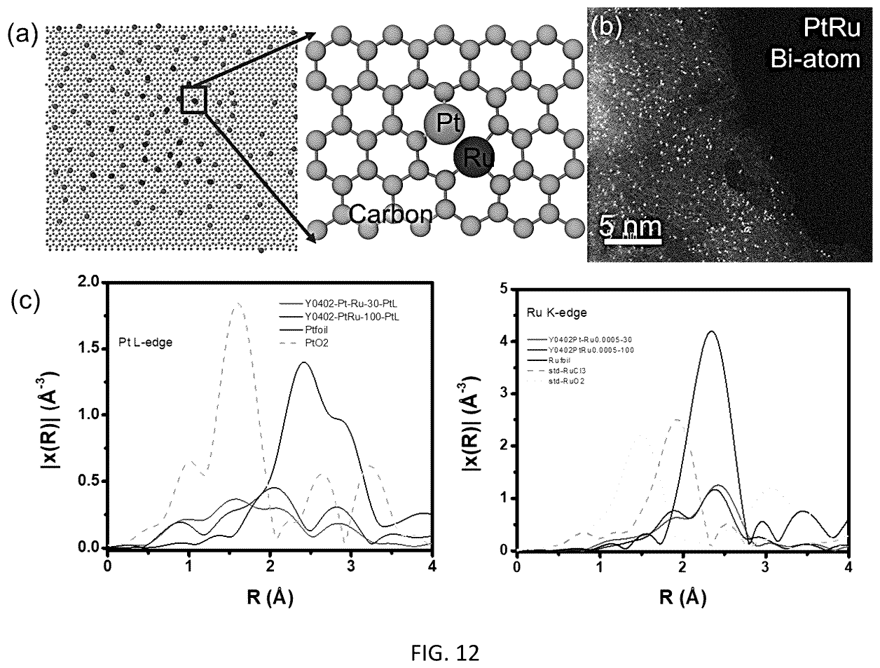

The paragraphs above describe application of HTHP process to synthesize Pu atoms. The HTHP synthesis process can be generally applied to other metals and substrates, in which high temperature enables atom dispersion by forming stable metal-defect bonds while the HTHP pulse heating helps maintain the overall stability. Since the HTHP temperature is sufficiently high compared with the thermal decomposition temperatures of most metal precursors, the HTHP process can be used to produce single atom dispersions of most metals, including Ru and Co single atoms on CA-CNFs, which is addressed in FIG. 11 and in Supplement, Fig. S14.

FIG. 11 shows graphs and images relating to applying the HTHP process to various atoms and substrates and for various applications. Portion (a) shows Co single atoms synthesized on CA-CNFs confirmed by the EXAFS profile and a HAADF image (inset). Portions (b) and (c) show Pt single atoms synthesized on C₃N₄ and TiO₂ substrates through radiative and conductive shockwave synthesis (˜0.5 wt %). Portion (d) shows the light-off curves, and portion (e) shows the Arrhenius plots of the Pt single atoms for the CO oxidation reaction before and after steam treatment at 973 K for 4 hours, showing a stable performance after hydrothermal treatment. Portion (f) shows the stable performance of the Pt single atoms during CO oxidation at 493 K for 50 hours. Portion (g) shows high temperature direct CH₄ conversion by Pt single atoms and Pt IMP samples at 973 K for 50 hours. Portion (h) shows the reaction turnover frequency (TOF) compared with the literature.

Additionally, with continuing reference to FIG. 11, the shockwave method can be extended to other substrates, such as conductive reduced graphene oxide, semiconductor C₃N₄ and oxides like TiO₂, but using a different heating method (Supplement, Fig. S15) and forming different bonds with the substrates (Supplement, Fig. S16). Radiative HTHP heating can be used for powder samples by depositing precursor-loaded powders beneath a carbon film that can be joule heated in a HTHP pulse pattern. The high temperature achieved in the film also heats the C₃N₄ powder and induces a high-density single atom dispersion (FIG. 11, portion (b)). In addition, the HTHP pulse heating maintains the structural integrity of C₃N₄ which otherwise would be easily carbonized by prolonged heating (Supplement, Fig. S17). The non-contact radiative heating can also be scaled up for continuous production (FIG. 8, and Supplement, Fig. S18). As oxides have poor thermal conductivity for effectively radiative heating, alternatively, Pt single atoms on TiO₂ substrates can be achieved by depositing a thin layer (˜2.5 nm) of TiO₂ on the nanofibers in CA-CNF film via atomic layer deposition (Supplement, Fig. S15c). The HTHP pulse heating of the CA-CNF film also heats the TiO₂ layer through conductive heating and induces single atom dispersion on TiO₂ (FIG. 11, portion (c)). These results demonstrate the general applicability of the HTHP process for synthesizing thermally stable single atom dispersions, which suggests great potential for scalable nanomanufacturing.

To test the stability of the HTHP synthesized single atoms, an in situ hydrothermal test can be performed for Pt single atoms on CA-CNFs in an environmental TEM (ETEM) at a partial H₂O pressure of 10⁻³ mbar from 300 K to 773 K (upper limit to avoid equipment corrosion), with each studied temperature held for at least 30 minutes. As shown in Supplement, Fig. S19, there is no nanocluster emerging during the in-situ measurement up to 773 K, demonstrating that the HTHP synthesized single atoms are stable. Further, the performance stability of the Pt HT-SAs in the CO oxidation reaction before and after hydrothermal treatment using 5% H₂O at 973 K for 4 hours, can be confirmed, corroborating the hydrothermal stability of the Pt single atoms (FIG. 11, portion (d)). The Arrhenius plots (FIG. 11, portion (e), measured by kinetic studies) show that the apparent reaction energies of the Pt single atom catalysts before and after the steam pretreatment are very close (50.7 kJ/mol vs 53.2 kJ/mol). In addition, performing multiple cycles of the CO oxidation measurements (Supplement, Fig. S20), as well as stability test at 493 K for 50 hours, confirm the high stability of the Pt single atoms (FIG. 11, portion (f)).

Additionally, HTHP synthesized single atoms for reductive catalytic application of direct methane conversion can be demonstrated, where single atom catalysts exhibit good performance due to the coke resistance by preventing catalytic C—C coupling. A control sample can be synthesized via conventional impregnation (i.e., IMP) method by using the same material but thermally reducing at 573 K for 1 hour (Supplement, Fig. S21). FIG. 11, portion (g), and Supplement, Fig. S22, display the performance of Pt IMP (Tₛ=573 K) and HTHP synthesized Pt single atoms (Tₛ=1500 K) for direct CH₄ conversion at 973 K to various products, such as ethylene, ethane, propylene, propane, butene, and benzene over the total hydrocarbon products. The product distribution shows a high selectivity for C₂H₄, C₂H₆, and C₆H₆ (>90%) for Pt single atoms and no coke formation. In contrast, the Pt IMP sample shows severe coke formation even during the first hour of reaction, which could be ascribed to the continuous ensembles and aggregation of Pt sites at a high temperature (973 K). FIG. 11, portion (h), shows the superior stability of the HTHP synthesized Pt single atoms in CH₄ conversion with a stable turnover frequency (TOF) for 50 hours, in contrast to the quick drop of TOF for Pt IMP sample due to its dispersion instability at high temperature. The HTHP synthesized single atoms demonstrate roughly 1000-times higher TOF than Pt-nanocluster-supported on SiO₂ catalysts reported in the literature under similar conditions, manifesting the great efficiency of single atom catalysts. Such practical results demonstrate the superior thermal stabilities of single atoms synthesized by the HTHP process and their great potential for catalytic applications.

Referring now to FIG. 12, there is shown diagrams and images relating to formation of Pt—Ru bi-atom on carbon nanofibers by the HTHP process. Portion (a) shows simulation efforts illustrating the dispersion of Pt—Ru into single atoms and formation of bi-metallic alloys. Portion (b) shows high resolution images of the atomic dispersion of Pt—Ru bi-atoms without clear segregation. Portion (c) shows the X-ray absorption profiles of Pt edge and Ru edge, showing that Pt—Ru in Pt—Ru bi-atoms are different from individual metal foils, indicating formation of Pt—Ru alloy bond.

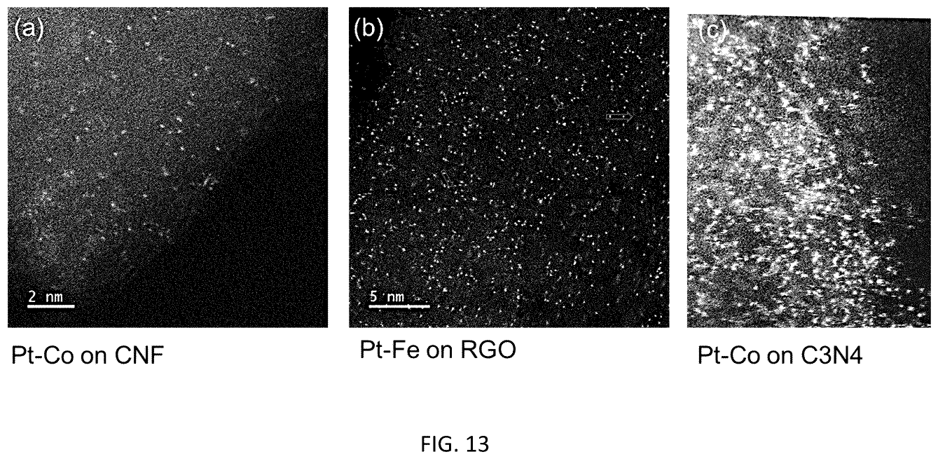

FIG. 13 shows high resolution atomic images of formation of bi-atoms on carbon and C₃N₄ substrates by the HTHP process. Portion (a) shows Pt—Co bi-atoms dispersion on carbon nanofibers (CNF). Portion (b) shows Pt—Fe bi-atoms dispersion on reduced graphene oxide (RGO). Portion (c) shows Pt—Co bi-atom dispersion on C₃N₄ substrates. No cluster formation is clearly visible in each image/sample.

Accordingly, the present disclosure provides a high temperature heating pulse process for synthesizing single atom dispersions and multi-atom dispersions on substrates. The high temperature pulses operate to disperse clusters and synthesize single atom dispersion on the substrates. The single atoms are stabilized by the defects on the substrates and by bonding with the substrate. For clarity, it is noted that the single atom dispersion effectuated by the HTHP process may not disperse every cluster and some clusters may remain after the HTHP process.

The HTHP pulse configuration and pattern is flexible, as shown in FIG. 2, and the high temperature (T_{high}), low temperature (T_{low}), heating duration (t_{high}), cooling duration (t_{low}), heating rate (R_{heating}), cooling rate (R_{cooling}), and cycle numbers (n) can be individually varied for the HTHP process.

The heating configuration is also flexible and can include, without limitation, direct Joule heating, conduction heating, radiative heating, microwave heating, laser heating, and/or plasma heating, as shown in FIGS. 3, 8, and 14. Also, different cooling processes can be implemented, including, but not limited to, cooling by radiation and conduction, active cooling by conduction and convection, and/or active cooling by physical or chemical transitions that absorbs heat.

Multi-atom groupings/atomic alloys can be formed by sequentially/iteratively applying the HTHP process, which enables single atom dispersion for one specie at a time. In such a process, the atoms in a multi-atom group can be different or can be the same, and can be either pure metal or its compound. The substrates can be carbon-based materials, metals, ceramics, polymer, composites, oxides, and/or their combinations.

General atomic alloys with different elemental combinations can be synthesized by sequentially applying the HTHP process with different elements at each iteration. In the process, a single atom can be any element that can be dispersed into atomic form, including their compound formation. The substrates can be carbon-based materials, metals, ceramics, polymer, composites, oxides, and/or their combinations.

The synthesized single atoms and multi-atom groupings/atomic alloys can be used for many different applications, including, without limitation, thermochemical, electrochemical, and photochemical catalysis. Also, the synthesis of single atoms and atomic alloys can be used for fundamental study of atomic manipulation.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that the foregoing description is only illustrative of the present disclosure. Various alternatives and modifications can be devised by those skilled in the art without departing from the disclosure. Accordingly, the present disclosure is intended to embrace all such alternatives, modifications and variances. The embodiments described with reference to the attached drawing figures are presented only to demonstrate certain examples of the disclosure. The embodiments described and illustrated herein are exemplary, and variations are contemplated to be within the scope of the present disclosure. Various embodiments disclosed herein can be combined in ways not expressly described herein, and such combinations are contemplated to be within the scope of the present disclosure. Other elements, steps, methods, and techniques that are insubstantially different from those described above and/or in the appended claims are also intended to be within the scope of the disclosure.

1. A method comprising:
providing one or more first precursors on a substrate; and
subjecting the substrate with the one or more first precursors thereon to multiple first heating cycles, each first heating cycle comprising a first temperature pulse applied to the substrate for a first duration and a first cooling period following the first temperature pulse,
wherein each first temperature pulse applies a temperature between 500 K and 4000 K, inclusive, and
each first duration is between 1 millisecond and 1 minute, inclusive.

2. The method of claim 1, wherein each first temperature pulse is applied by:
passing an electric current through the substrate to cause Joule heating thereof; or
passing an electric current through an electrically-conductive heating element to cause Joule heating thereof, the electrically-conductive heating element being disposed in contact with or proximal to the substrate.

3. The method of claim 1, wherein each first temperature pulse is applied by conduction heating, radiative heating, microwave heating, laser heating, or plasma heating.

4. The method of claim 1, wherein each first cooling period comprises:
passive cooling by radiation and/or conduction;
active cooling by conduction and/or convection; or
active cooling by a physical or chemical transition that absorbs heat.

5. The method of claim 1, wherein the substrate comprises a carbon-based material or oxide.

6. The method of claim 1, wherein, after the subjecting to multiple first heating cycles, a plurality of individual single first atoms are formed from the one or more first precursors, the single first atoms being separately dispersed on and bonded to the substrate.

7. The method of claim 6, wherein, after the subjecting to multiple first heating cycles, the substrate has a uniform distribution of the single first atoms.

8. The method of claim 6, wherein the one or more first precursors comprises a precursor of a first metal or a cluster of the first metal.

9. The method of claim 8, wherein the first metal is one of Pt, Ru, or Co.

10. The method of claim 8, further comprising, after the subjecting to multiple first heating cycles:
providing one or more second precursors on the substrate, the one or more second precursors comprising a precursor of a second metal or a cluster of the second metal;
subjecting the substrate with the one or more second precursors thereon to multiple second heating cycles, each second heating cycle comprising a second temperature pulse applied to the substrate for a second duration and a second cooling period following the second temperature pulse,
wherein each second temperature pulse applies a temperature between 500 K and 4000 K, inclusive,
each second duration is between 1 millisecond and 1 minute, inclusive, and
after the subjecting to multiple second heating cycles, a plurality of individual single second atoms, in addition the plurality of first atoms, are separately dispersed on and bonded to the substrate.

11. The method of claim 10, wherein the first metal and the second metal are different elements.

12. The method of claim 10, further comprising, after the subjecting to multiple second heating cycles:
providing one or more third precursors on the substrate, the one or more third precursors comprising a precursor of a third metal or a cluster of the third metal;
subjecting the substrate with the one or more third precursors thereon to multiple third heating cycles, each third heating cycle comprising a third temperature pulse applied to the substrate for a third duration and a third cooling period following the third temperature pulse,
wherein each third temperature pulse applies a temperature between 500 K and 4000 K, inclusive,
each third duration is between 1 millisecond and 1 minute, inclusive, and
after the subjecting to multiple third heating cycles, a plurality of individual single third atoms, in addition the plurality of first atoms and the plurality of second atoms, are separately dispersed on and bonded to the substrate.

13. The method of claim 12, wherein at least one of the second and third metals is a different element from the first metal.

14. The method of claim 6, wherein the substrate comprises a plurality of defects, and the defects stabilize the first atoms on the substrate.

15. The method of claim 1, wherein the providing one or more first precursors on the substrate is such that a loading of the one or more first precursors is less than 0.05 μmol/cm².

16. The method of claim 1, wherein:
a duration of the first cooling period in each first heating cycle is at least ten times the first duration; and/or
a number of the multiple first heating cycles is between 2 and 10, inclusive.

17. A structure comprising:
a carbon-based substrate comprising a plurality of defects; and
a single-atom dispersion formed by a plurality of individual single atoms of a first metal dispersed on and covalently bonded to carbon atoms of the substrate.

18. The structure of claim 17, wherein the first metal is one of Pt, Ru, and Co.

19. The structure of claim 17, wherein the substrate comprises carbon nanofibers.

20. The structure of claim 17, wherein the substrate has a uniform distribution of the individual single atoms of the first metal.
